(19) United States
(12) Patent Application Publication
(10) Pub. No.: US 2019/0071536 A1
(43) Pub. Date: Mar. 7, 2019

(54) A Process for the Preparation of Insulation Systems for Electrical Engineering, the Articles Obtained Therefrom and the Use Thereof

(71) Applicant: Huntsman Advanced Materials Licensing (Switzerland) GmbH, The Woodlands, TX (US)

(72) Inventors: Christian Beisele, Müllheim (DE); Hubert Wilbers, Schopfheim (DE); Daniel Baer, Riehen (CH)

(21) Appl. No.: 16/085,020

(22) PCT Filed: Feb. 10, 2017
(86) PCT No.: PCT/EP2017/052952

§ 371 Date: Sep. 14, 2018

(30) Foreign Application Priority Data
Mar. 15, 2016 (EP) 16160346.9

(51) Int. Cl. C08G 59/24; C08G 59/42; C08K 5/17; C08K 3/36; C08K 13/02; H01B 3/40; H01B 19/00; B29C 39/42; B29C 39/00; B29C 39/38

(52) U.S. Cl. CPC C08G 59/245; C08G 59/4238; C08K 5/17; C08K 3/36; C08K 13/02; B29K 2063/00; H01B 19/00; B29C 39/42; B29C 39/003; B29C 39/38; H01B 3/40

(57) ABSTRACT

A process for the preparation of insulation systems for electrical engineering by automatic pressure gelation (APG) or vacuum casting, wherein a multiple component thermosetting resin composition is used, said resin composition comprising
(A) at least one epoxy resin,
(B) at least one carboxylic acid anhydride curing agent, and
(C) 2,4,6-tris(dimethylaminomethyl)phenol,
   provides encased articles exhibiting good mechanical, electrical and dielectrical properties, which can be used as, for example, insulators, bushings, switchgears and instrument transformers.

The present invention relates to a process for the preparation of insulation systems for electrical engineering by automatic pressure gelation (APG) or vacuum casting, wherein a multiple component thermosetting epoxy resin composition is used. The insulation encased articles obtained by the process according to the present invention exhibit good mechanical, electrical and dielectrical properties and can be used as, for example, insulators, bushings, air core reactors, hollow core insulators, switchgears and instrument transformers.

Epoxy resin compositions containing anhydride hardeners in combination with benzyldimethylamine (BDMA) as curing accelerator are commonly used for the preparation of insulation systems for electrical engineering. However, BDMA has recently been classified as toxic (skull & bone label).

Furthermore, the relatively high vapour pressure of BDMA requires a rather complex degassing process. Either the epoxy resin, anhydride and filler are mixed in a first step and degassed under very low pressure followed by addition of BDMA at a later stage at normal pressure; the final composition is subsequently degassed by application of a less severe vacuum. Alternatively, all components are mixed in the initial step and degassing is carried out by application of moderate vacuum which may cause partial discharge.

These disadvantages might be avoided if BDMA is replaced with an accelerator which is less toxic and less volatile, like 1-methylimidazole. The pot-life of such curable epoxy resin compositions containing an anhydride curing agent and 1-methylimidazole as curing catalyst, however, is too short for the application in the APG or vacuum casting process. Moreover, the cured products are adversely affected by insufficient toughness properties.

It has now unexpectedly been found that the above-mentioned problems can satisfactorily be solved if an epoxy resin in combination with an anhydride hardener and 2,4,6-tris(dimethylaminomethyl)phenol (TDMAMP) is applied in the APG or vacuum casting process.

Accordingly, the present invention relates to a process for the preparation of insulation systems for electrical engineering by automatic pressure gelation (APG) or vacuum casting, wherein a multiple component thermosetting resin composition is used, said resin composition comprising

(A) at least one epoxy resin,
(B) at least one carboxylic acid anhydride curing agent, and
(C) 2,4,6-tris(dimethylaminomethyl)phenol.

Generally, insulation systems are prepared by casting, potting, encapsulation, and impregnation processes such as gravity casting, vacuum casting, automatic pressure gelation (APG), vacuum pressure gelation (VPG), infusion, trickle impregnation, pultrusion, filament winding and the like.

A typical process for making insulation systems for electrical engineering, such as cast resin epoxy insulators, is the automatic pressure gelation (APG) process. The APG process allows for the preparation of a casting product made of an epoxy resin in a short period of time by hardening and forming the epoxy resin. In general, an APG apparatus to carry out the APG process includes a pair of molds (hereafter called mold), a resin mixing tank connected to the mold through a pipe, and an opening and closing system for opening and closing the mold.

Before injection of the curable epoxy resin composition into the hot mold, the components of the curable composition comprising the epoxy resin and the curing agent have to be prepared for injection.

In case of a pre-filled system, i.e. a system comprising components which already contain the filler, it is required to stir the components in the supply tank while heating to prevent sedimentation and obtain a homogeneous formulation. After homogenization, the components are combined and transferred into a mixer and mixed at elevated temperature and reduced pressure to degas the formulation. The degassed mixture is subsequently injected into the hot mold.

In case of a non-pre-filled system, the epoxy resin component and the curing agent component are typically mixed individually with the filler at elevated temperature and reduced pressure to prepare the pre-mixture of the resin and the curing agent. Optionally, further additives may be added beforehand. In a further step, the two components are combined to form the final reactive mixture, typically by mixing at elevated temperature and reduced pressure. Subsequently, the degassed mixture is injected into the mold.

In a typical APG process, a metal conductor or an insert, which is pre-heated and dried, is placed into the mold located in a vacuum chamber. After closing of the mold by an opening and closing system, the epoxy resin composition is injected into the mold from an inlet located at the bottom of the mold by applying pressure to the resin mixing tank. Before injection, the resin composition is normally held at a moderate temperature of 40 to 60° C. to ensure an appropriate pot life (usable time of the epoxy resin), while the temperature of the mold is kept at around 120° C. or above to obtain the casting products within a reasonably short time. After injection of the epoxy resin composition into the hot mold, the resin composition cures while the pressure applied to the epoxy resin in the resin mixing tank is kept at about 0.1 to 0.5 MPa.

Large casting products made of more than 10 kg of resin may be produced conveniently by the APG process within a short time, for example, of from 20 to 60 minutes. Normally, the casting product released from the mold is post cured in a separate curing oven to complete the reaction of the epoxy resin.

The epoxy resin (A) is a compound containing at least one vicinal epoxy group, preferably more than one vicinal epoxy group, for example, two or three vicinal epoxy groups. The epoxy resin may be saturated or unsaturated, aliphatic, cycloaliphatic, aromatic or heterocyclic and may be substituted. The epoxy resin may also be a monomeric or a polymeric compound. A survey of epoxy resins useful for the use in the present invention can be found, for example, in Lee, H. and Neville, Handbook of Epoxy Resins, McGraw-Hill Book Company, New York (1982).

The epoxy resins, used in embodiments disclosed herein for component (A) of the present invention, may vary and include conventional and commercially available epoxy resins, which may be used alone or in combinations of two or more. In choosing epoxy resins for the compositions disclosed herein, consideration should not only be given to properties of the final product, but also to viscosity and other properties that may influence the processing of the resin composition.

Particularly suitable epoxy resins known to the skilled worker are based on reaction products of polyfunctional alcohols, phenols, cycloaliphatic carboxylic acids, aromatic amines, or aminophenols with epichlorohydrin.

Aliphatic alcohols which come into consideration for reaction with epichlorhydrin to form suitable polyglycidyl ethers are, for example, ethylene glycol and poly(oxyethylene)glycols such as diethylene glycol and triethylene glycol, propylene glycol and poly(oxypropylene)-glycols, propane-1,3-diol, butane-1,4-diol, pentane-1,5-diol, hexane-1,6-diol, hexane-2,4,6-triol, glycerol, 1,1,1-trimethylolpropane, and pentaerythritol.

Cycloaliphatic alcohols which come into consideration for reaction with epichlorhydrin to form suitable polyglycidyl ethers are, for example, 1,4-cyclohexanediol (quinitol), 1,1-bis(hydroxymethyl)cyclohex-3-ene, bis(4-hydroxycyclohexyl)methane and 2,2-bis(4-hydroxycyclohexyl)-propane.

Alcohols containing aromatic nuclei which come into consideration for reaction with epichlorhydrin to form suitable polyglycidyl ethers are, for example, N,N-bis-(2-hydroxyethyl)aniline and 4,4′-bis(2-hydroxyethylamino)diphenylmethane.

Preferably the polyglycidyl ethers are derived from substances containing two or more phenolic hydroxy groups per molecule, for example resorcinol, catechol, hydroquinone, bis(4-hydroxyphenyl)methane (bisphenol F), 1,1,2,2-tetrakis(4-hydroxyphenyl)ethane, 4,4′-dihydroxydiphenyl, bis(4-hydroxyphenyl)sulphone (bisphenol S), 1,1-bis(4-hydroxylphenyl)-1-phenyl ethane (bisphenol AP), 1,1-bis(4-hydroxylphenyl)ethylene (bisphenol AD), phenol-formaldehyde or cresol-formaldehyde novolac resins, 2,2-bis(4-hydroxyphenyl)propane (bisphenol A), and 2,2-bis(3,5-dibromo-4-hydroxyphenyl) propane.

Another few non-limiting embodiments include, for example, triglycidyl ethers of para-aminophenols. It is also possible to use a mixture of two or more epoxy resins.

The epoxy resin component (A) is either commercially available or can be prepared according to processes known per se. Commercially available products are, for example, D.E.R. 330, D.E.R. 331, D.E.R.332, D.E.R. 334, D.E.R. 354, D.E.R. 580, D.E.N. 431, D.E.N. 438, D.E.R. 736, or D.E.R. 732 available from The Dow Chemical Company, or ARALDITE® MY 740 or ARALDITE® CY 228 from Huntsman Corporation.

The amount of epoxy resin (A) in the final composition is, for example, of from 30 weight percent (wt %) to 92 wt %, based on the total weight of components (A) and (B) in the composition. In one embodiment, the amount of epoxy resin (A) is, for example, of from 45 wt % to 87 wt %, based on the total weight of components (A) and (B). In another embodiment, the amount of the epoxy resin (A) is, for example, of from 50 wt % to 82 wt %, based on the total weight of components (A) and (B).

In a preferred embodiment of the present invention the epoxy resin (A) is a diglycidylether of a bisphenol A or a cycloaliphatic epoxy resin.

In a further preferred embodiment the epoxy resin (A) is a diglycidylether of bisphenol A.

In principle, all anhydrides of difunctional and higherfunctional carboxylic acids may be suitable as curing agents (B), like linear aliphatic polymeric anhydrides, for example polysebacic acid polyanhydride or polyazelaic acid polyanhydride or cyclic carboxylic acid anhydrides, the latter being preferred.

Cyclic carboxylic acid anhydrides are preferably alicyclic monocyclic or polycyclic anhydrides, aromatic anhydrides or chlorinated or brominated anhydrides.

Examples of alicyclic monocyclic anhydrides are succinic anhydride, citraconic anhydride, itaconic anhydride, alkenylsubstituted succinic anhydrides, dodecenylsuccinic anhydride, maleic anhydride and tricarballylic anhydride.

Examples of alicyclic polycyclic anhydrides are maleic anhydride adduct of methylcyclopentadiene, nadic anhydride, linolic acid adduct of maleic anhydride, alkylated endoalkylenetetrahydrophthalic anhydride, tetrahydrophthalic anhydride, methyltetrahydrophthalic anhydride, the isomer mixture of the latter two being particularly suitable. Also preferred is hexahydrophthalic anhydride.

Examples of aromatic anhydrides are pyromellitic dianhydride, pyromellitic anhydride and phthalic anhydride.

Examples of chlorinated and brominated anhydrides are tetrachlorophthalic anhydride, tetrabromophthalic anhydride, dichloromaleic anhydride and chlorendic anhydride.

Preferably, liquid or readily melting dicarboxylic acid anhydrides are used in the multiple component thermosetting resin composition according to the invention.

Particularly preferred are compositions containing as carboxylic acid anhydride curing agent (B) phthalic anhydride, tetrahydrophthalic anhydride, methyltetrahydrophthalic anhydride, hexahydrophthalic anhydride or methylhexahydrophthalic anhydride.

The proportions of carboxylic acid anhydride (B) and accelerator TDMAMP (C) to be used will depend on such factors as as the epoxide content of the epoxy resin used, the nature of the anhydride hardening agent and the curing conditions which may be employed. Optimum proportions may readily be determined by routine experimentation.

Usually, the thermosetting resin composition contains components (A) and (B) in amounts of 0.4-1.6 acid anhydride equivalents per epoxy equivalent, preferably 0.6-1.4 acid anhydride equivalents per epoxy equivalent, especially 0.8-1.2 acid anhydride equivalents per epoxy equivalent.

Practically, the thermosetting resin composition contains 0.05-3.0 parts by weight, preferably 0.1-2.0 parts by weight, more preferably 0.5-1.0 parts by weight, of 2,4,6-tris(dimethylaminomethyl)phenol based on 100 parts by weight of epoxy resin.

The multiple component thermosetting resin composition according to the process of the present invention may contain one or more fillers (D) generally used in electrical insulations which are selected from the group consisting of metal powder, wood flour, glass powder, glass beads, semi-metal oxides, metal oxides, metal hydroxides, semi-metal and metal nitrides, semi-metal and metal carbides, metal carbonates, metal sulfates, and natural or synthetic minerals.

Preferred fillers are selected from the group consisting of quartz sand, silanised quartz powder, silica, aluminium oxide, titanium oxide, zirconium oxide, Mg(OH)₂, Al(OH)₃, dolomite [CaMg(CO₃)₂], silanised Al(OH)₃, AlO(OH), silicon nitride, boron nitrides, aluminium nitride, silicon carbide, boron carbides, dolomite, chalk, CaCO₃, barite, gypsum, hydromagnesite, zeolites, talcum, mica, kaolin and wollastonite. Especially preferred is wollastonite, calcium carbonate or silica, in particular silica flour.

The filler material may optionally be coated for example with a silane or a siloxane known for coating filler materials, e.g. dimethylsiloxanes which may be cross linked, or other known coating materials.

The amount of filler in the final composition is, for example of from 30 weight percent (wt %) to 75 wt %, based on the total weight of the thermosetting epoxy resin composition. In one embodiment, the amount of filler is, for example, of from 40 wt % to 75 wt %, based on the total weight of the thermosetting epoxy resin composition. In another embodiment, the amount of filler is, for example, of from 50 wt % to 70 wt %, based on the total weight of the thermosetting epoxy resin composition. In still another embodiment, the amount of filler is, for example, of from 60 wt % to 70 wt %, based on the total weight of the thermosetting epoxy resin composition.

Further additives may be selected from processing aids to improve the rheological properties of the liquid mix resin, hydrophobic compounds including silicones, wetting/dispersing agents, plasticizers, reactive or non-reactive diluents, flexibilizers, accelerators, antioxidants, light absorbers, pigments, flame retardants, fibers and other additives generally used in electrical applications. These additives are known to the person skilled in the art.

In a preferred embodiment the multiple component thermosetting resin composition is prepared by mixing components (A), (B), (C) and optionally (D) and subsequently degassing the mixture by application of vacuum. The low-pressure usually applied in the degassing step amounts 0.1-5.0 mbar, preferably 0.5-2.0 mbar.

In a further preferred embodiment the mixture containing components (A), (B), (C) and optionally (D) is heated to 40-80° C. prior to the application of vacuum.

The present invention also refers to the use of a multiple component thermosetting resin composition comprising
(A) at least one epoxy resin
(B) at least one carboxylic acid anhydride curing agent, and
(C) 2,4,6-tris(dimethylaminomethyl)phenol
   for the preparation of insulation systems for electrical engineering by automatic pressure gelation (APG) or vacuum casting.

Preparation of insulation systems for electrical engineering is often carried out by Automatic Pressure Gelation (APG) or Vacuum Casting. When using conventional epoxy resin compositions based on anhydride cure, such processes typically include a curing step in the mold for a time sufficient to shape the epoxy resin composition into its final infusible three dimensional structures, typically up to ten hours, and a post-curing step of the demolded article at elevated temperature to develop the ultimate physical and mechanical properties of the cured epoxy resin composition. Such a post-curing step may take, depending on the shape and size of the article, up to thirty hours.

The process according to the present invention is useful for the preparation of encased articles exhibiting good mechanical, electrical and dielectrical properties.

Accordingly, the present invention refers to an insulation system article obtained by the process according to the present invention. The glass transition temperature of the article is in the same range as for known high temperature cure anhydride based thermosetting epoxy resin compositions.

Possible uses of the insulation system articles prepared according to the present invention are dry-type transformers, particularly cast coils for dry type distribution transformers, especially vacuum cast dry distribution transformers, which within the resin structure contain electrical conductors; medium and high-voltage insulations for indoor and outdoor use, like breakers or switchgear applications; medium and high voltage bushings; as long-rod, composite and cap-type insulators, and also for base insulators in the medium-voltage sector, in the production of insulators associated with outdoor power switches, measuring transducers, bushings, and overvoltage protectors, in switchgear constructions, in power switches, and electrical machines, as coating materials for transistors and other semiconductor elements and/or to impregnate electrical installations.

In particular the articles prepared in accordance with the inventive process are used for medium and high voltage switchgear applications and instrument transformers (6 kV to 72 kV).

The following Examples serve to illustrate the invention. Unless otherwise indicated, the temperatures are given in degrees Celsius, parts are parts by weight and percentages relate to % by weight. Parts by weight relate to parts by volume in a ratio of kilograms to litres.

TABLE 1
Raw materials used in the Examples

| Component | Description |
|---|---|
| ARALDITE ® | liquid, low viscous bisphenol A diglycidylether, |
| CY 228 | epoxide content 5.0-5.3 eq/kg (supplier: Huntsman, |
| | Switzerland) |
| ARADUR ® | liquid anhydride curing agent based on methyltetra- |
| HY 918 | hydrophthalic anhydride and methylhexahydrophthalic |
| | anhydride (supplier: Huntsman, Switzerland) |
| ARADUR ® | liquid anhydride curing agent based on methyltetra- |
| HY 918-1 | hydrophthalic anhydride (supplier: Huntsman, |
| | Switzerland) |
| ACCELERATOR | benzyldimethylamine (BDMA, supplier: Huntsman, |
| DY 062 | Switzerland) |
| ACCELERATOR | 1-methylimidazole (supplier: Huntsman, Switzerland) |
| DY 070 | |
| TDMAMP | 2 4 6-tris(dimethylaminomethyl)phenol (supplier: |
| | Air Products) |
| MILLISIL ® | Silica flour (supplier: Quarzwerke, Germany) |
| W 12 | |
| QZ 12 | Mould release agent, low-viscous silicone oil |
| | (supplier: Huntsman, Switzerland) |

### EXAMPLE 1

In a heatable steel vessel 100 g of ARALDITE® CY 228 is mixed with 85 g of ARADUR® HY 918 and 0.7 g TDMAMP. The mixture is heated to about 60° C. for about 5 min while slightly stirring with a propeller stirrer. Under stirring 345 g of silica W12 is added in portions and the mixture is heated up to 60° C. under stirring for about 10 minutes. Then the mixer is stopped and the vessel is carefully degassed under vacuum (about 1 min). The reactivity of this mixture is measured at various temperatures using a gel norm gel timer equipment.

The main part of the mixture is poured into a 140° C. hot steel mold (treated with mold release agent QZ13) to prepare plates of thickness 4 mm or 10 mm thick, respectively (for determination of mechanical properties respectively the thermal conductivity). The mold is then cured in an oven at 140° C. for 10 hours. Afterwards, the mold is taken out of the oven and opened and the 4 mm plates are taken out and let cool down to ambient temperature.

### EXAMPLE 2

In a heatable steel vessel 100 g of ARALDITE® CY 228 is mixed with 85 g of ARADUR® HY 918-1 and 0.7 g TDMAMP. The mixture is heated to about 60° C. for about 5 minutes while stirring slightly with a propeller stirrer. Under stirring 345 g of silica W12 is added in portions and the mixture is heated up to 60° C. under stirring for about 10 minutes. Then the mixer is stopped and the vessel is degassed carefully under vacuum (about 1 minute). The reactivity of this mixture is measured at various temperatures using a gel norm gel timer equipment.

The main part of the mixture is poured into a 140° C. hot steel mold (treated with mold release agent QZ13) to prepare plates of thickness 4 mm or 10 mm thick, respectively (for determination of mechanical properties respectively the thermal conductivity). The mold is then put to an oven at 140° C. for 10 hours for curing. Afterwards, the mold is taken out of the oven and opened and the 4 mm plates are taken out and let cooled down to ambient temperature.

### COMPARATIVE EXAMPLE 1

In a heatable steel vessel 100 g of ARALDITE® CY 228 is mixed with 85 g of ARADUR® HY 918 and 0.8 g DY 062. The mixture is heated to about 60° C. for about 5 min while slightly stirring with a propeller stirrer. Under stirring 345 g of silica W12 is added in portions and the mixture is heated up to 60° C. under stirring for about 10 minutes. Then the mixer is stopped and the vessel is carefully degassed under vacuum (about 1 min).

The reactivity of this mixture is measured at various temperatures using a gel norm gel timer equipment.

The main part of the mixture is poured into a 140° C. hot steel mold (treated with mold release agent QZ13) to prepare plates of thickness 4 mm or 10 mm thick, respectively (for determination of mechanical properties respectively the thermal conductivity). The mold is then cured in an oven at 140° C. for 10 hours. Afterwards, the mold is taken out of the oven and opened and the 4 mm plates are taken out and let cool down to ambient temperature.

### COMPARATIVE EXAMPLE 2

In a heatable steel vessel 100 g of ARALDITE® CY 228 is mixed with 85 g of ARADUR® HY 918-1 and 0.8 g DY 062. The mixture is heated to about 60° C. for about 5 min while slightly stirring with a propeller stirrer. Under stirring 345 g of silica W12 is added in portions and the mixture is heated up to 60° C. under stirring for about 10 minutes. Then the mixer is stopped and the vessel is carefully degassed under vacuum (about 1 min). The reactivity of this mixture is measured at various temperatures using a gel norm gel timer equipment.

The main part of the mixture is poured into a 140° C. hot steel mold (treated with mold release agent QZ13) to prepare plates of thickness 4 mm or 10 mm thick, respectively (for determination of mechanical properties respectively the thermal conductivity). The mold is then cured in an oven at 140° C. for 10 hours. Afterwards, the mold is taken out of the oven and opened and the 4 mm plates are taken out and let cool down to ambient temperature.

### COMPARATIVE EXAMPLE 3

In a heatable steel vessel 100 g of ARALDITE® CY 228 is mixed with 85 g of ARADUR® HY 918 and 1 g DY 070. The mixture is heated to about 60° C. for about 5 min while slightly stirring with a propeller stirrer. Under stirring 345 g of silica W12 is added in portions and the mixture is heated up to 60° C. under stirring for about 10 minutes. Then the mixer is stopped and the vessel is carefully degassed under vacuum (about 1 min). The reactivity of this mixture is measured at various temperatures using a gel norm gel timer equipment.

The main part of the mixture is poured into a 140° C. hot steel mold (treated with mold release agent QZ13) to prepare plates of thickness 4 mm or 10 mm thick, respectively (for determination of mechanical properties respectively the thermal conductivity). The mold is then cured in an oven at 140° C. for 10 hours. Afterwards, the mold is taken out of the oven and opened and the 4 mm plates are taken out and let cool down to ambient temperature.

TABLE 2
Formulations and Test Results

| Components | Ex. 1 | | Ex. 2 | | Comp. Ex. 1 | | Comp. Ex. 2 | | Comp. Ex. 3 | |
|---|---|---|---|---|---|---|---|---|---|---|
| ARALDITE ® CY 228 | 100 | g | 100 | g | 100 | g | 100 | g | 100 | g |
| ARADUR ® HY 918 | 85 | g | | | 85 | g | | | 85 | g |
| ARADUR ® HY 918-1 | | | 85 | g | | | 85 | g | | |
| DY 062 | | | | | 0.8 | g | 0.8 | g | | |
| DY 070 | | | | | | | | | 1.0 | g |
| TDMAMP | 0.7 | g | 0.7 | g | | | | | | |
| W 12 | 345 | g | 345 | g | 345 | g | 345 | g | 345 | g |

| Gel time at 140° C. | 4 min 30 s | 4 min 30 s | 4 min 20 s | 4 min 30 s | 3 min 20 s |
|---|---|---|---|---|---|
| T_{g}/° C. | 117 | 111 | 115 | 117 | 120 |
| Tensile strength/MPa | 82 | 80 | 85 | 77 | |
| Elongation at break | 1.00% | 0.90% | 0.85% | 0.90% | |
| Flexural strength/MPa | 119 | 116 | 120 | 122 | 100.6 |
| K_{1C}/MPa · √m | 2.10 | 2.30 | 2.05 | 2.10 | 1.92 |
| G_{1C}/J/m² | 343 | 377 | 350 | 343 | 316 |
| CTE | 33.2 | 34.9 | 33.1 | 37.2 | |
| TC/W/mK | 1.02 | 1.05 | 0.95 | 0.99 | |
| SCT/° C. | −39 | −18 | −21 | 0 | |

| | | | | | |
|---|---|---|---|---|---|
| Vapor pressure/mbar | 0.001 | 0.001 | 3.0 | 3.0 | 0.5 |

T_{g} (glass transition temperature) was determined according to ISO 6721/94.
Tensile strength and elongation at break were determined at 23° C. according to ISO R527.
Flexural strength was determined at 23° C. according to ISO 178.
K_{1C} (critical stress intensity factor) and G_{1C} (specific break energy) were determined at 23° C. by double torsion experiment (Huntsman-internal method).
CTE (coefficient of thermal expansion) was determined according to DIN 53752.
TC (thermal conductivity) was determined according to ISO 8894.
SCT: Crack index (simulated crack temperature) was calculated based on T_{g}, G_{1C}, CTE and elongation at break according to the description given in WO 2010/112272.

### EXAMPLE 4

An iron part is placed in a mould and encapsulated with a formulation according to Example 1 in the APG process and cured for 10 h at 140° C. The cured encapsulated part is subjected to a thermal cycle test.

### COMPARATIVE EXAMPLE 4

An iron part of same geometry than the part used in Example 4 is placed in a mould and encapsulated with a formulation according to Comparative Example 1 in the APG process and cured for 10 h at 140° C. The cured encapsulated part is subjected to a thermal cycle test. The average crack temperature (based on a set of 20 samples each) is 14 K higher than that of the product of Example 4.

The combination widely used today in APG processes with slightly different hardeners is described in Comparative Examples 1 and 2. Such systems are toxicologically questionable in those cases where the customer is handling BDAM as a separate component and is adding the accelerator at the end of the mixing and degassing process into the well degassed mixture of anhydride and filler, what is advisable due to the relatively high vapor pressure of BDMA. The simulated crack temperature (calculated from T₉, CTE, elongation at break and G_{1C}) as a measure for the thermal cycle crack performance results in −21 and 0° C. respectively.

Comparative Example 3 shows that the substitution of BDMA as accelerator with the less toxic 1-methylimidazole results in more brittle systems with a tendencially higher T₉, lower toughness (lower G_{1C}), lower strength and a lower elongation at break.

Inventive Examples 1 and 2 distinguish from Comparative Examples 1 and 2 only with respect to the curing accelerator. The inventive advantages are:
TDMAMP is toxicologically unproblematic.
Due to the lower vapor pressure it is possible to add the accelerators at an earlier step of the mixing and degassing process and thus there is no need of interrupting the process to add the accelerator at a later step. There is only a very low tendency to distill off the accelerator during the mixing and degassing step.
Both inventive examples show the much better SCT values (−18 K better for both examples compared to the comparative examples).
A further advantage of the inventive formulations is the slightly better thermal conductivity.
The use of TDMAMP as catalyst is more effective: 0.7 pbw of TDMAMP results in the same reactivity as 0.8 pbw of BDMA.
In comparison to 1-methylimidazole a longer pot-life (gel time) is achieved by application of TDMAMP.
The APG process provides cured products showing lower average crack temperature.

What is claimed is:

1. A process for the preparation of insulation systems for electrical engineering by automatic pressure gelation (APG) or vacuum casting, wherein a multiple component thermosetting resin composition is used, said resin composition comprising
(A) at least one epoxy resin,
(B) at least one carboxylic acid anhydride curing agent, and
(C) 2,4,6-tris(dimethylaminomethyl)phenol.

2. The process according to claim 1, wherein the said at least one epoxy resin (A) is a diglycidylether of a bisphenol or a cycloaliphatic epoxy resin.

3. The process according to claim 2, wherein the said at least one epoxy resin (A) is a diglycidylether of bisphenol A.

4. The process according to any one of claims 1-3, wherein the said at least one carboxylic acid anhydride curing agent (B) is phthalic anhydride, tetrahydrophthalic anhydride, methyltetrahydrophthalic anhydride, hexahydrophthalic anhydride or methylhexahydrophthalic anhydride.

5. The process according to any one of claims 1-4, wherein the multiple component thermosetting resin composition additionally contains (D) a filler.

6. The process according to claim 5, wherein the multiple component thermosetting resin composition contains silica flour as component (D).

7. The process according to any one of claims 1-6, wherein the thermosetting resin composition contains components (A) and (B) in amounts of 0.4-1.6 acid anhydride equivalents per epoxy equivalent.

8. The process according to any one of claims 1-7, wherein the thermosetting resin composition contains 0.05-3.0 parts by weight of 2,4,6-tris(dimethylaminomethyl)phenol based on 100 parts by weight of epoxy resin.

9. The process according to claim 1, wherein the multiple component thermosetting resin composition is prepared by mixing components (A), (B), (C) and optionally (D) and subsequently degassing the mixture by application of vacuum.

10. The process according to claim 9, wherein the mixture containing components (A), (B), (C) and optionally (D) is heated to 40-80° C. prior to the application of vacuum.

11. The use of a multiple component thermosetting resin composition comprising
(A) at least one epoxy resin
(B) at least one carboxylic acid anhydride curing agent, and
(C) 2,4,6-tris(dimethylaminomethyl)phenol
for the preparation of insulation systems for electrical engineering by automatic pressure gelation (APG) or vacuum casting.

12. An article obtained by the process according to any one of claims 1 to 10.

13. Use of the article according to claim 12 for medium and high voltage switchgear applications and as medium and high voltage instrument transformers.
